(19) United States
(12) Patent Application Publication
(10) Pub. No.: US 2010/0194812 A1
(43) Pub. Date: Aug. 5, 2010

(54) MEDIA ADVANCE SYSTEM FOR A PRINTER AND METHOD OF ADVANCING A PRINT MEDIUM

(75) Inventors: Raimon CASTELLS, Barcelona (ES); Daniel Gutierrez, Barcelona (ES); Fernando Juan, Viladecavalls (ES); Abel Martinez, Barcelona (ES)

Correspondence Address: HEWLETT-PACKARD COMPANY;Intellectual Property Administration, 3404 E. Harmony Road, Mail Stop 35, FORT COLLINS, CO, 80528, US

(73) Assignee: HEWLETT-PACKARD DEVELOPMENT COMPANY, L.P.

(21) Appl. No.: 12/363,560

(22) Filed: Jan. 30, 2009

(51) Int. Cl. B41J 29/38; B41J 2/01

(52) U.S. Cl. 347/16; 347/104

(57) ABSTRACT

A media advance system for a printer, the system comprising: a drive roller for advancing the print medium, said drive roller being mounted on a first spindle, a second rotary element mounted on a second spindle for applying tension to the print medium downstream of said drive roller, a drive motor operatively connected to said first spindle, and a second motor operatively connected to said second spindle, wherein the velocity of the drive motor is constantly adjustable and the velocity of the second motor is constantly adjustable to the instantaneous velocity of the drive motor.

### FIELD OF THE INVENTION

The present invention relates to a media advance system for a printer and a method of advancing a print medium.

### BACKGROUND OF THE INVENTION

A printer is generally used for (re)producing text and images. Throughout this application, when reference is made to an image or images, this is to be interpreted as also explicitly referring to text (not only figures).

Different types of printers are known, amongst which laser printers, thermal printers, dot matrix printers and inkjet printers.

Inkjet printers use at least one printhead provided with a plurality of nozzles, from which ink droplets are fired or ejected onto the media; the printer controls the firing of ink from the nozzles such as to create on the media a pattern of dots corresponding to the desired image.

In one type of inkjet printers, the printheads may be mounted on a carriage that reciprocates in successive passes above a print medium along a scan direction, with the nozzles firing droplets of ink as the printhead moves across the medium; after each printing pass of the printheads, the medium is advanced in a media advance direction, at right angles to the scan direction, such that a plot is formed on the medium in successive passes of the printheads. These printheads are sometimes referred to as scanning printheads or shuttle printheads. These printers are sometimes referred to as shuttle printers.

In another type of inkjet printers, the printhead extends over the width of the printer and is static when printing. The nozzles of the printhead fire droplets of ink while the medium advances in a media advance direction. The printheads are sometimes referred to as page wide printheads or full width printheads. These printers are sometimes referred to as full width printers.

Regardless of the kind of printing apparatus used, a print medium is generally supplied from a medium input and collected by a medium output, a print zone being located between the medium input and the medium output. Said print medium is advanced through the printing apparatus using a media advance mechanism, which may comprise one or more rollers, controlled by one or more motorised drives. Additionally said mechanism may comprise one or more passive rollers.

In order to obtain a printed image of good quality, it is important that the part of the print medium in the print zone is kept under appropriate tension. To achieve such tension, the media advance mechanism should be configured and operated appropriately. Additionally, to avoid creases or folds in the print medium, the print medium should be under appropriate tension along other parts of its path from input to output as well.

### SUMMARY OF THE INVENTION

A goal of the present invention is therefore to provide a media advance mechanism and a method of advancing a print medium which keeps the print medium under appropriate tension.

According to a first aspect, the present invention provides a media advance system for a printer, the system comprising: a drive roller for advancing the print medium, said drive roller being mounted on a first spindle, a second rotary element mounted on a second spindle for applying tension to the print medium downstream of said drive roller, a drive motor operatively connected to said first spindle, and a second motor operatively connected to said second spindle, wherein the velocity of the drive motor is constantly adjustable and the velocity of the second motor is constantly adjustable to the instantaneous velocity of the drive motor.

A drive roller, mounted on a first spindle, advances the print medium towards a print zone (e.g. in an inkjet printer, a printhead). The velocity of the drive motor and thus the drive roller can constantly be adjusted to be able to print any kind of image. Downstream of said drive roller, a second rotary element is provided (the first rotary element being the drive roller). Said second rotary element is mounted on a second spindle, which is operatively connected to a second motor. The second rotary element may e.g. be a roller which is able to provide tension to the medium by cooperating with a pinch roller. Alternatively, said second rotary element may also be a roll of print medium, upon which the print medium is wound after passing through the print zone. By constantly adjusting the velocity of the second motor to the instantaneous velocity of the drive motor, the tension of the print medium between the drive roller and output spindle can be maintained at an appropriate level, regardless of the image to be printed, print medium used and instantaneous velocity of the drive motor. An image can thus be printed with a sufficient accuracy even if the velocity of the drive motor is varied. Adjusting the velocity of the second motor to the velocity of the drive motor does not necessarily mean that the velocity of the second motor is the same as the velocity of the drive motor. It merely means that the velocity of the second motor is such that, taking the instantanous velocity of the drive motor into account, appropriate tension is applied to the print medium between drive roller and second rotary element.

Constantly adjusting the velocity of the motors in this sense is meant to refer to adjusting the velocity of the motors very frequently. The exact frequency with which the velocity of the motors can be adjusted may vary from one embodiment to another and may depend on the hardware or software used. In some embodiments of the invention, the frequency of adjustment may be between 0.6 kHz and 1.5 kHz.

In another aspect, the present invention provides a method of advancing a print medium through a printing apparatus, wherein a drive roller controls the advancement of the print medium and a second rotary element provides tension to the print medium downstream of said drive roller, the method comprising the following steps: calculating a first velocity profile to be applied to the drive roller for printing, wherein at least a part of said first velocity profile comprises a variable velocity, applying said first velocity profile to said drive roller, and while applying said first velocity profile to said drive roller, calculating an instantaneous second velocity based on an instantaneous first velocity and applying said instantaneous second velocity to said second rotary element.

In yet another aspect, the present invention provides a method of printing in an inkjet printer comprising the steps of: advancing a print medium from a supply roll to a take-up roll for printing on said print medium with a shuttle printhead, said shuttle printhead reciprocating in successive printing passes above the print medium; after each printing pass of the printhead, advancing the print medium by a drive roller; driving the take-up roll in such a way as to maintain substantially constant tension in the print medium between the drive roller and the take-up roll.

### BRIEF DESCRIPTION OF THE DRAWING

Particular embodiments of the present invention will be described in the following, only by way of non-limiting example, with reference to the appended drawings, in which:

FIG. 1 is a schematic view of a first embodiment of a printer according to the present invention;

FIG. 2 is a schematic view of a second embodiment of a printer according to the present invention;

FIG. 3 is a flow diagram of an embodiment of the method of advancing a medium according to the present invention;

FIGS. 4a and 4b show exemplary velocity profiles of a supply roll, a drive roller and a take-up roll in an embodiment of the present invention.

### DESCRIPTION OF THE PREFERRED EMBODIMENTS

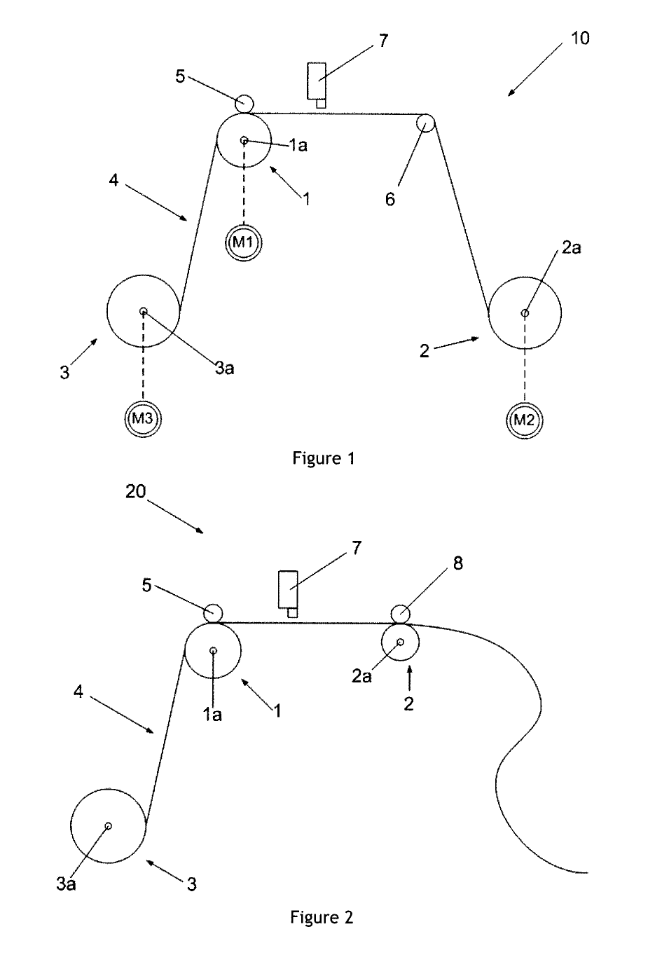

An embodiment of a printer according to the invention is shown schematically in FIG. 1. The printer 10 shown is a so-called roll-to-roll printer. This kind of printer may be used for printing large images on various kinds of media, such as textile or paper. The printed products may e.g. be used on billboards or to mask scaffolding. Printer 10 comprises a printhead 7 comprising a plurality of nozzles for firing droplets of ink on print medium 4. Said printhead 7 may be a full-width printhead or a scanning printhead.

A drive roller 1 advances the print medium towards printhead 7. To this end, a pinch roller 5 is provided which forces the print medium into contact with drive roller 1. The drive roller is thus able to exert enough friction to the print medium to advance it accurately. Alternatives to a pinch roller may also be used. It is e.g. known to provide a drive roller with a surface that increases the friction between the drive roller and the print medium.

The drive roller 1, mounted on first spindle 1a may be regarded as a first rotary element. A drive motor M1 is operatively connected with spindle 1a of the drive roller. A second rotary element 2 is mounted upon a spindle 2a downstream from said drive roller 1. In the embodiment shown in this figure, the second rotary element is a take-up roll 2, upon which the medium is wound after printing. The spindle 2a is operatively connected to a second motor M2. Rotating second motor M2 exerts a pulling force on the print medium and thus applies tension to it. This tension makes it possible to print images with increased accuracy.

Printer 10 furthermore comprises a third rotary element 3. Said third rotary element is mounted upon spindle 3a, which is operatively connected to a third motor M3. Third rotary element 3 in this embodiment is a print medium supply roll from which print medium is unwound for printing. By properly driving the third motor, the tension of the print medium between the drive roller 1 and the third roll 3 can be controlled. Appropriate tension in the print medium here avoids creases and folds in the print medium before it reaches the drive roller.

In some embodiments, a DC motor is provided for rotating each of the spindle 1a of drive roller 1, spindle 2a of second rotary element 2 and spindle 3a of third rotary element 3. The velocity profile of the drive motor M1 (and thus the drive roller 1) has to be adapted to the image to be printed. To obtain an accurate image, the tension of the print medium in the print zone, located between drive roller 1 and take-up roll 2, should be maintained at appropriate levels. The velocity of the second motor M2, operatively connected to take-up roll 2 is therefore constantly adjusted to the instantaneous velocity of the drive roller 1. This does not mean that the velocity of the take-up roll 2 is constantly the same as the velocity of the drive roller. It means that the velocity of the take-up roll is such that the print medium is under appropriate tension, e.g. the second roll may momentarily rotate faster than the drive roller.

In printer 10, apart from the take-up roll 2, also the velocity of supply roll 3 may be constantly adjusted to the instantaneous velocity of drive roller 1. In this way, the tension of the print medium can also be managed on the print medium supply side, between the supply roll 3 and the drive roller 1.

The velocity profiles of the second and third motors thus primarily take into account the velocity profile of the drive roller. The motors operatively connected to first spindle 1a, second spindle 2a and third spindle 3a in this embodiment may be controlled through Pulse Width Modulation (PWM) signals. A PWM signal determines the power sent to the stator of the motor and thus determines the torque the motor applies to the spindle connected to it.

The PWM signals for the second motor and the third motor may also take into account the amount of print medium that is wound respectively on the supply roll and take-up roll in order to follow the desired velocity profile. The amount of print medium wound upon these rolls determines the inertia of the roll and thereby the torque that needs to be applied to follow a certain velocity profile.

In an embodiment of the invention, a user of the printer can determine the tension that is to be applied to the print medium by inputting data through a user input interface. The tension can thus be adjusted to an appropriate value for each print medium. When a print medium is changed e.g. from paper to textile, the velocity profiles of the various motors and thereby the tension that is applied to the medium by the motors may thus be adapted.

In FIG. 1, drive motor M1, second motor M2, and third motor M3, have been schematically indicated, through the use of dotted lines, to be operatively connected to their respective spindles. It is to be understood that the motors can be operatively connected to the spindles in any suitable way e.g. through suitable gearings, with or without a clutch mechanism, or by a direct connection.

FIG. 2 shows another embodiment of a printer according to the present invention. Printer 20 is comparable in many aspects to printer 10 shown in FIG. 1. However, contrary to FIG. 1, the print medium is not collected upon a take-up roll. Printer 20 is a so-called roll-to-floor printer. As in the previous example, printer 20 comprises a drive roller 1 for advancing the print medium towards a printhead 7 and a second rotary element 2 for applying tension to the print medium downstream of said drive roller. Second rotary element 2 is mounted on second spindle 2a, operatively connected to a second motor (not shown). Second rotary element in this embodiment is a roller 2, cooperating with a pinch roller 8. Third rotary element 3 is mounted on third spindle 3a, which is operatively connected to a third motor (not shown). Third rotary element 3 is also in this embodiment a print medium supply roll.

The operation of printer 20 is further similar to the operation of printer 10 shown in FIG. 1. The velocity profiles of second and third motors are adapted to the velocity profile followed by first motor.

In the embodiments of the invention shown in FIGS. 1 and 2, the print medium was supplied from the third rotary element, which serves as a print medium supply roll. In other embodiments, the third rotary element may be a roller (e.g. like roller 2 of FIG. 2) whereas the print medium is supplied from a roll downstream from the third rotary element.

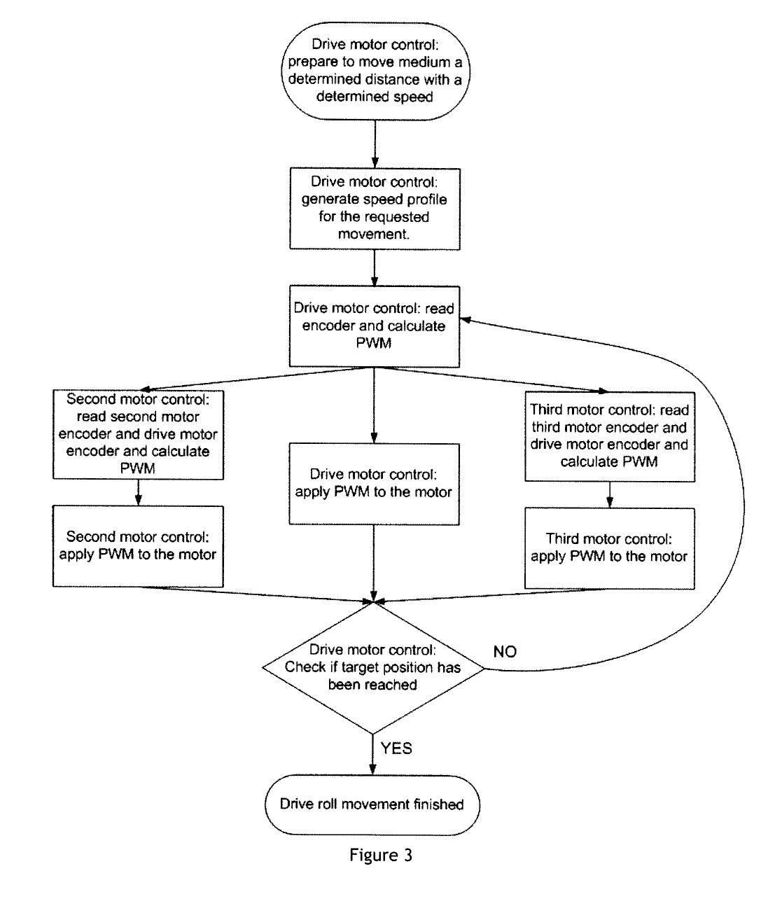

FIG. 3 shows a flow diagram of an embodiment of a method of advancing a print medium according to the present invention. In an embodiment of a printer according to the present invention, the drive roller, second rotary element and third rotary element may each be driven by a DC motor fitted with an encoder. Each of the DC motors comprises a control system for calculating a Pulse Width Modulation (PWM) signal that is to be applied to the DC motors to rotate the motors with the appropriate torque to rotate them an appropriate amount with the appropriate velocity. The encoder provides information about the momentary angular position of the motors.

Depending on the image that is to be printed, the drive roller has to move the print medium a determined distance (and with a determined velocity). The drive roller control system thus has to determine the velocity profile the drive roller has to follow to be able to print the desired image. Once the velocity profile that the drive roller has to follow has been determined, the drive motor control system calculates the PWM signal that needs to be applied instantaneously to the drive motor to follow said velocity profile.

Based on the instantaneous position and velocity of the drive roller and the instantaneous position of the second rotary element, the second motor control system can calculate the PWM signal that needs to be applied to the second motor such that the print medium between the drive roller and the second rotary element is under appropriate tension. At the same time, based on the instantaneous position and velocity of the drive roller and the instantaneous position of the third rotary element, the third motor control system can do the same for the third rotary element such that the print medium between the third rotary element and the drive roller is under appropriate tension.

After the respective PWM signals have been calculated, these signals are provided to the DC motors. After each PWM signal, the exact position of the print medium is determined and a check is performed whether the print medium has reached its target position (with respect to the printhead) by checking the angular position of the drive roller. If the print medium has reached its target position, the drive roller movement is ended momentarily. If the print medium has not yet reached its target position, the PWM signal that needs to be applied to the drive motor is calculated as previously described. The PWM signals for the second motor and third motor are thus also calculated again. The cycle continues until the print medium has reached its target position.

The drive roller's function is thus to accurately position the print medium. The second and third rotary elements serve to maintain the print medium under appropriate tension.

In other embodiments of the invention, other kinds of motors, such as synchronous or asynchronous motors may be used. In other embodiments of the invention, also other types of control than PWM signals may be used. Any type of voltage control is particularly suitable for the control of DC motors. The type of control used may be adapted to the type of motor used.

In the embodiment described before, every motor comprises its own control system. In other embodiments of the invention however, a printer may comprise a central control system, which functions as drive motor control system, second motor control system and third motor control system, controlling every motor of the print medium advance mechanism. Alternatively, a central control system may be provided which communicates with a separate drive motor control system, a separate second motor control system and a separate third motor control system. Also, a control system may comprise any combination of software, hardware or firmware.

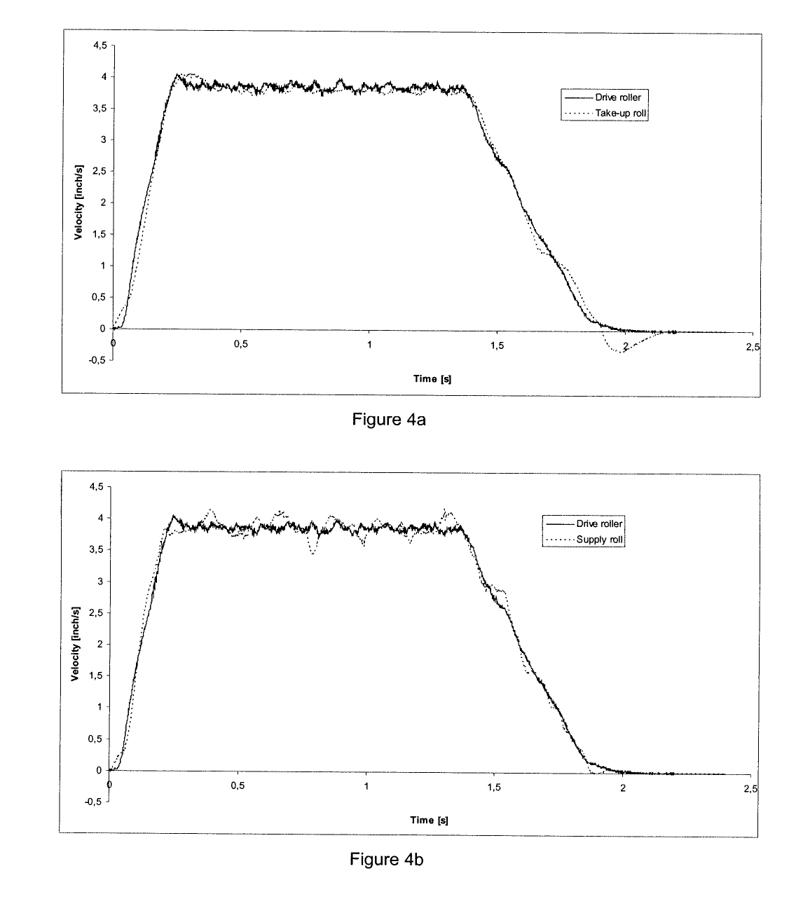

FIGS. 4a and 4b show the velocity profiles of a drive roller, a take-up roll and a supply roll (operatively connected to drive motor, second motor and third motor respectively) in an embodiment of a printer according to the present invention. The printer in this case is an inkjet roll-to-roll printer (such as the one shown in FIG. 1). The printhead used is a shuttle printhead. In FIGS. 4a and 4b, the advancement of the drive roller in between two successive print passes is shown. During a print pass, the shuttle printhead reciprocates above the media along a scan direction, with the nozzles firing droplets of ink as the printhead moves across the media. In between print passes, the drive roller is substantially at rest.

FIG. 4a shows the velocity profiles of a drive roller and a take-up roll in an embodiment of the present invention between two successive print passes. FIG. 4b shows the velocity profiles of the drive roller and a supply roll in the same embodiment over the same time period. The velocity displayed is in inch per second, which refers to the velocity of the circumference of the drive roller, take-up roll and supply roll respectively.

As can be seen in FIGS. 4a and 4b, the velocity profiles of the second and third motor are adjusted to the instantaneous velocity profile of the drive motor, in this case, to maintain substantially constant tension in the print medium from supply roll to take-up roll. At certain instants, the take-up roll rotates faster than the drive roller: this applies more tension to the print medium between drive roller and take-up roll. At other instants, the velocity of the take-up roll is lower than the velocity of the drive roller: this reduces the tension of the print medium between drive roller and take-up roll.

Similarly, at some instants, the supply roll rotates slower than the drive roller: this applies more tension to the print medium between supply roll and drive roller. At other instants, the supply roll rotates faster than the drive roller: this reduces the tension in the print medium between supply roll and drive roller.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described before, but should be determined only by a fair reading of the claims that follow.

1. A media advance system for a printer, the system comprising:
a drive roller for advancing the print medium, said drive roller being mounted on a first spindle,
a second rotary element mounted on a second spindle for applying tension to the print medium downstream of said drive roller,
a drive motor operatively connected to said first spindle, and
a second motor operatively connected to said second spindle,
wherein the velocity of the drive motor is constantly adjustable and the velocity of the second motor is constantly adjustable to the instantaneous velocity of the drive motor.

2. A media advance system according to claim 1, further comprising a third rotary element on a third spindle for applying tension upstream of said drive roller, and a third motor operatively connected to said spindle.

3. A media advance system according to claim 2, wherein also the velocity of the third motor is constantly adjustable to the velocity of the drive motor.

4. A media advance system according to claim 2, wherein the drive motor, the second motor and the third motor are DC motors controlled by Pulse Width Modulation (PWM) signals.

5. A media advance system according to claim 4, wherein the DC motors are fitted with encoders, for determining the angular position of each motor spindle.

6. A printer comprising a media advance system according to claim 1.

7. A printer according to claim 6, further a comprising a user input interface, in which a user can input data concerning the print medium.

8. An inkjet printer comprising a media advance system according to claim 5, further comprising a shuttle printhead.

9. An inkjet printer according to claim 8, wherein said third rotary element is a supply roll, from which the print medium is unwound for printing.

10. An inkjet printer according to claim 9, wherein the PWM signal to be applied to the third motor is determined taking the amount of print medium wound upon the supply roll into account.

11. An inkjet printer according to claim 8, wherein said second rotary element is a take-up roll, upon which the print medium is wound after printing.

12. An inkjet printer according to claim 11, wherein the PWM signal to be applied to the second motor is determined taking the amount of print medium wound upon the second roll into account.

13. A method of advancing a print medium through a printing apparatus, wherein a drive roller controls the advancement of the print medium and a second rotary element provides tension to the print medium downstream of said drive roller, the method comprising the following steps:
calculating a first velocity profile to be applied to the drive roller for printing, wherein at least a part of said first velocity profile comprises a variable velocity,
applying said first velocity profile to said drive roller, and
while applying said first velocity profile to said drive roller, calculating an instantaneous second velocity based on an instantaneous first velocity and applying said instantaneous second velocity to said second rotary element.

14. A method according to claim 13, wherein the printer furthermore comprises a third rotary element that provides tension to the print medium upstream of said drive roller, and the method also comprises the steps of calculating an instantaneous third velocity based on the instantaneous first velocity and applying said instantaneous third velocity to said third rotary element.

15. A method according to claim 14, wherein the second and third velocities are calculated for maintaining constant tension in the print medium.

16. A method according to claim 15, wherein the second and third velocities are also based on the instantaneous drive roller position.

17. A method according to claim 14, wherein the second and third velocities are also based on the print medium that is used.

18. A method according to claim 14, wherein the print medium is supplied by unwinding the print medium from a supply roll mounted on said third spindle and the print medium is collected by winding the print medium upon a take-up roll mounted on said second spindle.

19. A method of printing in an inkjet printer comprising the steps of:
advancing a print medium from a supply roll to a take-up roll for printing on said print medium with a shuttle printhead, said shuttle printhead reciprocating in successive printing passes above the print medium;
after each printing pass of the printhead, advancing the print medium by a drive roller; driving the take-up roll in such a way as to maintain substantially constant tension in the print medium between the drive roller and the take-up roll.

20. A method of printing according to claim 19, wherein the supply roll is also driven in such a way as to maintain substantially constant tension in the print medium between the supply roll and the drive roller.
